(19) United States
(12) Patent Application Publication
(10) Pub. No.: US 2011/0138177 A1
(43) Pub. Date: Jun. 9, 2011

(54) ONLINE PUBLIC KEY INFRASTRUCTURE (PKI) SYSTEM

(75) Inventors: Xin Qiu, San Diego, CA (US); Alexander Medvinsky, San Diego, CA (US); Stuart P. Moskovics, San Diego, CA (US); John H. Kim, San Jose, CA (US)

(73) Assignee: GENERAL INSTRUMENT CORPORATION, Horsham, PA (US)

(21) Appl. No.: 12/961,455

(22) Filed: Dec. 6, 2010

Related U.S. Application Data
(60) Provisional application No. 61/266,757, filed on Dec. 4, 2009.

(51) Int. Cl. G06F 15/16; H04L 9/32

(52) U.S. Cl. 713/168; 709/219

(57) ABSTRACT

A method is provided for updating network-enabled devices with new identity data. The method includes requesting new identity data for a plurality of network-enabled devices and receiving notification that the new identity data is ready to be delivered to the plurality of network-enabled devices. A software object is delivered to the plurality of network-enabled devices over a first communications network. Each of the software objects is configured to cause the network-enabled devices to download the new identity data to the respective network-enabled device over a second communications network and install the new identity data at a time based at least in part on information included with the software object.

### CROSS REFERENCE TO RELATED APPLICATIONS

This application claims priority to U.S. Provisional patent application No. 61/266,757, filed Dec. 4, 2009, entitled “Online PKI Service.” The disclosure of which is incorporated herein by reference.

### BACKGROUND

Digital information has become extremely important in all aspects of commerce, education, government, entertainment and management. In many of these applications, the ability to ensure the privacy, integrity and authenticity of the information is critical. As a result, several digital security mechanisms have been developed to improve security.

One commonly used approach to digital security involves a certificate authority (CA) to issue a certificate to a certificate holder. The holder can then provide the certificate to a third party as an attestation by the CA that the holder who is named in the certificate is in fact the person, entity, machine, email address user, etc., that is set forth in the certificate. And that a public key in the certificate is, in fact, the holder's public key. People, devices, processes or other entities dealing with the certificate holder can rely upon the certificate in accordance with the CA's certification practice statement.

A certificate is typically created by the CA digitally signing, with its own private key, identifying information submitted to the CA along with the public key of the holder who seeks the certificate. A certificate usually has a limited period of validity, and can be revoked earlier in the event of compromise of the corresponding private key of the certificate holder, or other revocable event.

One standardized approach to today's digital security is referred to as the Public Key Infrastructure (PKI). PKI provides for use of digital certificates to authenticate the identity of a certificate holder, or to authenticate other information. Typically, a PKI certificate includes a collection of information to which a digital signature is attached. A CA that a community of certificate users trusts attaches its digital signature and issues the certificates to various users and/or devices within a system.

Network-enabled devices are generally provisioned with identity data so that they may communicate with other network-enabled devices in a secure manner using a PKI system. The identity data typically includes a public and private key pair and a digital certificate. Illustrative examples of networked-enabled device include, without limitation, PCs, mobile phones, routers, media players, set-top boxes and the like.

The identity data is often provisioned in network-enabled devices before they are deployed in the field. For instance, the identity data may be incorporated into the device at the time of manufacture. For a variety of reasons, it may be necessary to occasionally update the identity data after the device have been deployed. For example, this can be a difficult and cumbersome process because it is often performed manually and therefore can require the devices to be returned to a service center.

### SUMMARY

In accordance with one aspect of the invention, a method is provided for updating network-enabled devices with new identity data. The method includes requesting new identity data for a plurality of network-enabled devices and receiving notification that the new identity data is ready to be delivered to the plurality of network-enabled devices. A software object is delivered to the plurality of network-enabled devices over a first communications network. Each of the software objects is configured to cause the network-enabled devices to download the new identity data to the respective network-enabled device over a second communications network and install the new identity data at a time based at least in part on information included with the software object.

In accordance with another aspect of the invention, a method is provided for providing new identity data that is to replace prior identity data currently being used by a plurality of network-enabled devices. The method includes receiving a request for new identity data for a plurality of network-enabled devices and generating the new identity data for each network-enabled device specified with its own identifier on a whitelist. The new identity data is encrypted for each network-enabled device with a unique key that is accessible only to each respective network-enabled device and not other network-enabled devices. The new identity data is loaded onto an on-line server accessible to the network-enabled devices over a communications network. The network-enabled devices are notified that the new identity data is ready to be downloaded.

In accordance with yet another aspect of the invention, a method is provided for updating identity data in a network-enabled device. The method includes installing in a network-enabled device a software object received over a first communications network. Responsive to instructions from the software object, a request is sent over a second communications network to receive new identity data for the network-enabled device to replace current identity data currently being used by the network-enabled device. The new identity data is received in an encrypted form over the second communications network and decrypted using a cryptographic key included in the current identity data. The decrypted identity data is installed to replace the current identity data.

### BRIEF DESCRIPTION OF THE DRAWINGS

FIG. 1 shows a simplified schematic diagram of an illustrative PKI management system that a manufacturer may use to provision their products with identity data such as public and private keys and/or digital certificates.

FIG. 2 shows one example of a system that may be employed to update identity data in network-enabled devices that have previously been provisioned with identity data.

FIG. 3 is a message flow diagram illustrating one example of a method for provisioning network-enabled devices with updated identity data such as PKI identity data.

FIG. 4 shows in more detail the message exchange process between the online PKI server and the network-enabled device which corresponds to messages 16-19 in FIG. 1.

### DETAILED DESCRIPTION

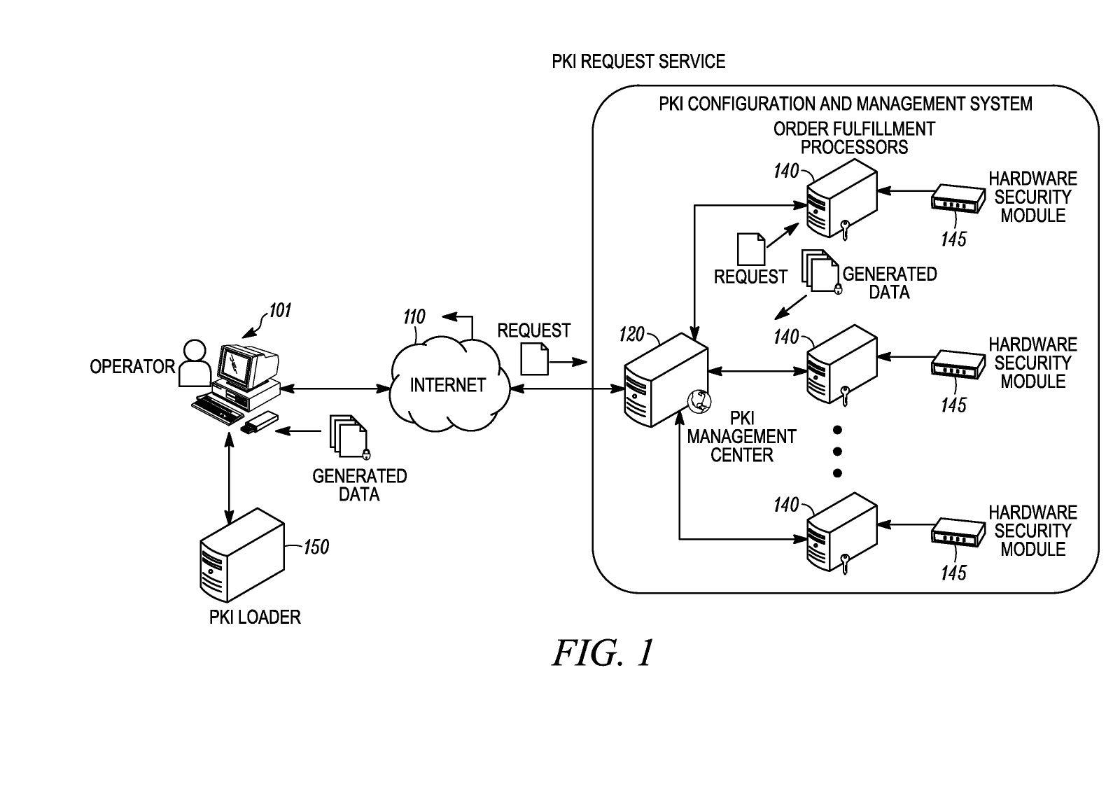

FIG. 1 shows a simplified schematic diagram of an illustrative PKI management system that a manufacturer may use to provision their products (e.g., provision network-enabled devices) with identity data such as public and private keys and/or digital certificates. The system includes an operator 101 who, in this example, accesses and interacts with the system through a PKI management center 120. The PKI management system typically includes one or more physical server computers with one or more physical storage devices and databases as well as various processing engines. In particular, in the example shown in FIG. 1, the system includes order fulfillment processors 140 which generate digital certificates or other identity data requested for products. The order fulfillment processors may include, or have access to, hardware security modules (HSMs) 145 in which the CA's certificate signing private keys and secure data may be stored for use by the system. The PKI management system may include a number of other devices and databases not shown in FIG. 1. For instance, the PKI management system may contain a database of records. These records may pertain to issued digital certificates, original requests for new digital certificates or secure data, audit data, organization information, product configurations, user information, and other record types as necessary.

The identity data generated by the order fulfillment processors 140 is returned to the operator 101. The operator, in turn, delivers the identity data to a PKI loader 150, which can cause the data to be provisioned into the devices that are produced. For security reasons the identity data that is generated may not be communicated to or from the operator over a network. For example, the operator may transfer the identity data to the PKI loader 150 using removable media such as a flash drive. In some cases the PKI loader 150 itself may not transfer the identity data directly to the device, but may first transfer it to one or more intermediate servers before the data is loaded into the devices. An example of such an arrangement may be found in U.S. Pat. Appl. Pub. No. 2008/0049942.

As previously mentioned, it may be desirable to update identity data after a series of products has been deployed in the field. For instance, a service provider may have acquired, say, 500,000 units of a product that they have delivered to their end user customers. For one reason or another the service provider may wish to update the identity data in all or a subset (e.g., 100,000) of those units.

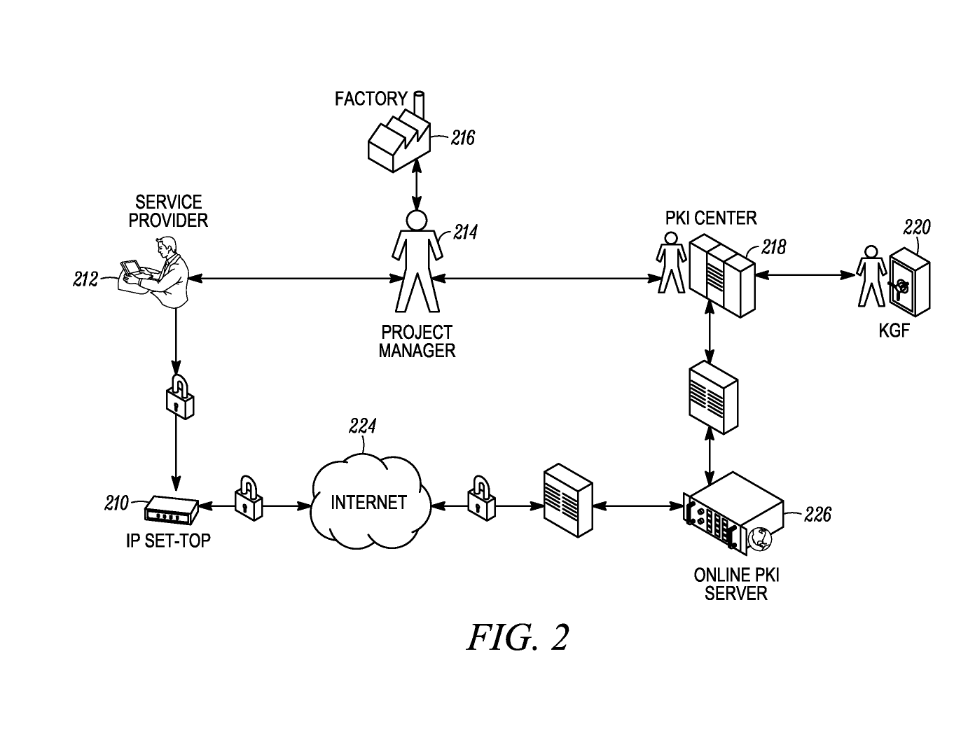

FIG. 2 shows one example of a system that may be employed to update identity data in network-enabled devices that have previously been provisioned with identity data. The system allows the devices to be updated without requiring the end users to bring the devices to a service center. In this example, which is presented for illustrative purposes only, the devices being provisioned with the updated data are set top boxes 210 which are operated by a service provider 212. In the case of a set-top box, the service provider may be a multi-service operator (MSO) that operates a cable network.

The service provider 212 contacts a manufacturer representative such as a product manager 214 and requests new identity data for their already-deployed devices (e.g., set-top boxes). The service provider 212 may contact the product manager 214 in any suitable manner. For instance, the service provider 212 and product manager 214 may communicate with one another over a public network such as the Internet and/or a private network. The product manager 214, in turn, prepare, or has prepared, a whitelist that contains the device IDs which uniquely identifies the devices that the manufacturer has previously delivered to this particular service provider 212. The device IDs may be a serial number, a MAC address, or any other suitable identifier. In this example the product manager 214 communicates with the factory 216 that manufactured the devices, which prepares the whitelist and returns it to the product manager 214.

In one alternative implementation, the service provider 212 may prepare the whitelist and deliver it to the product manager 214. This increases flexibility because the service provider can specify that only a subset of their devices should be updated. In contrast, when the manufacturer prepares the whitelist, all the devices that were delivered to the service provider will be included.

Once the product manager 214 receives the whitelist, the product manager 214 submits it to the PKI management center 218, which oversees the PKI process and controls and maintains the identity data that is generated. In some cases the PKI management center 218 includes a web portal, which provides a single front-end interface that is accessed by a client-based application such as a conventional web browser. In this case the product manager 214 may then submit the whitelist through the web portal. The PKI management center 218 obtains identity data from a key generation facility (KGF), which generates the identity data for the devices specified in the whitelist. The KGF may be an online or offline facility.

Once the PKI management center 218 obtains the necessary identity data for the devices specified in the whitelist, it loads them onto an on-line PKI server 226. The on-line PKI server 226 is accessible to the network-enabled devices that are to be updated over the Internet 222.

In one implementation, before being loaded onto the PKI server 226, the identity data for each device is secured so that it can only be accessed by the device for which it is intended. For example, the identity data for each device may be encrypted with a unique key that is only available to that device. The unique key may be a secret key or private key. For simplicity and convenience the unique key may be the current private key for each respective device. Of course, the private keys currently being used by the devices may be part of the identity data that is being updated. Thus, the current private key may be used to decrypt the new private key (as well as other secret identity data that may be being updated) before the current private key becomes inoperative. Along with the encrypted device identity data, the online PKI server may also be loaded with associated public identity data such as a device public key and a digital certificate.

At this point the identity data is available so that it can be accessed by the network-enabled devices over the Internet 224. To accomplish this, the devices need to be instructed by the service provider 212 to perform the actions necessary to obtain the identity data. In one implementation the service provider 212 can deliver software objects to the devices that implement the interface to the online PKI server. The software objects may also initiate the device identity download and installation process. The software objects may be delivered to the devices over a public network such as the Internet. Alternatively, it may be delivered over a private network. For instance, if the network-enabled devices are set-top boxes as in the example of FIG. 2, the service provider may deliver the software over its own cable network with which the set-top boxes are in communication.

Among other things, the objects software delivered to the network-enabled devices may specify where (e.g., a network address of the PKI server 226 such as a URL) and when the updated identity data will be available. If all the devices to be updated were to attempt to obtain the identity data from the PKI server 226 at the same time, the server 226 could be overloaded. Accordingly, it may be advantageous to stagger the times at which the devices download the identity data. This can be accomplished in a variety of different ways. For instance, the software objects may instruct the devices to contact the PKI server 226 at a randomly selected time within a specified time period (e.g., three days). Alternatively, as another example, the software objects may specify a specific time at which the each device should download the software.

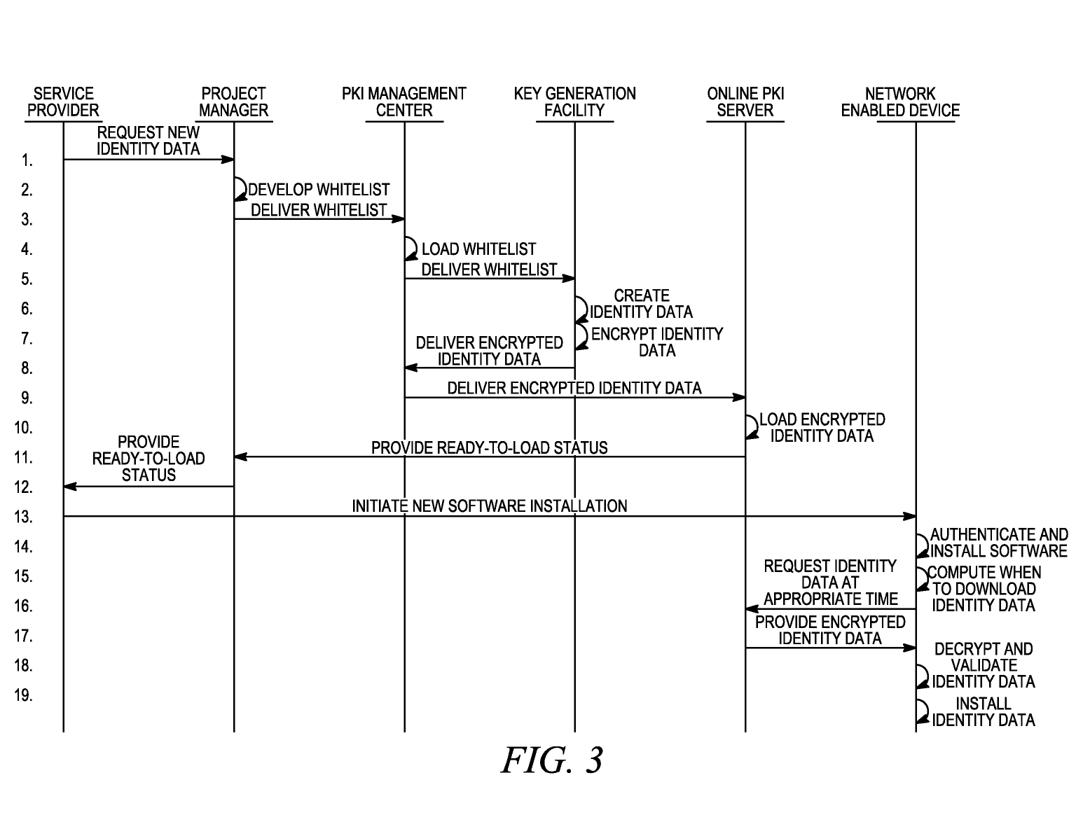

FIG. 3 is a message flow diagram illustrating one example of a method for provisioning network-enabled devices with updated identity data such as PKI identity data, which may include digital certificates and/or cryptographic keys. In this example the process begins at 1 when a service provider who is responsible for various network-enabled devices of its customers requests new PKI identity data for those devices. The service provider directs the request to the appropriate person or entity affiliated with the manufacturer. In this example the request is sent to an authorized project manager. At 2, the product manager develops the whitelist for this service provider. The whitelist in this example is a file that contains the Unique Addresses (UAs) which uniquely identify each of the service provider's devices. Only the end devices with the corresponding UAs in the whitelist will be updated with the new PKI data. Optionally, as previously mentioned, the whitelist may be obtained directly from the service provider. For security, the project manager may digitally sign the whitelist before submission for authentication.

The product manager delivers the whitelist to the online PKI management center at 3, which loads the whitelist at 4. The whitelist information is stored in a secure database that is only accessible to an online PKI server affiliated with the PKI management center. The PKI management center determines how many new UAs are needed, along with the types of digital certificates that are needed since different devices may need different certificate types. At 5, this information is delivered to the key generation facility. The key generation facility is offline and cannot be accessed by the online PKI server. Only authorized administrators may enter the facility and create PKI data for the end devices.

The key generation facility generates the identity data at 6 and encrypts it at 7. If the identity data includes digital certificates, they are signed using the private keys of the certificate authority (CA), which that are stored in HSMs associated with the key generation facility. The HSMs ensure that the private keys are secure against unauthorized tampering and duplication. In some cases the key generation facility encrypts all the identify data in order to protect the PKI data from unauthorized access and modification during its transit to the network-enabled devices. In other cases it only encrypts the private keys that may be included in the identity data. The key generation facility delivers the encrypted identity data to the PKI management center at 8. The management center serves to securely transport the encrypted identity data from the offline key generation facility to the Online PKI server.

The online PKI Server receives the encrypted identity data at 9 and loads it at 10. The PKI server stores the encrypted identity data in its secure database for subsequent delivery to the network-enabled devices. Once the identity data is ready for delivery to the network-enabled devices the PKI server notifies the product manager at 11 with a ready to download status message and the product manager, in turn, delivers the message to the service provider at 12. The status message may include the expiration date after which the identity data will no longer be available to the network-enabled devices.

After the service provider has received the status message it delivers at 13 the software object or objects needed by the network-enabled devices to download and install the identity data. At 14 the network-enabled devices authenticate and install the new software from the service provider. After the installation is successfully completed, the installed software determines at 15 the date and time at which the identity data should be downloaded from the online PKI server. In some cases the device may generate a random offset within a time window specified in the software. With a sufficiently large time window, there should be a sufficiently even distribution of time slots available during which the network-enabled devices can attempt to download the identity data with a low probability of collision.

At the appropriate time each network-enabled device requests at 16 the identity data from the online PKI server. The request may include the device's certificate and UA as well as a timestamp, and, optionally, a service provider ID. The service provider ID associates the request from the device with its service provider. The Online PKI server may use the operator ID to log the transaction. In response to the request, each device and the online PKI server perform a security handshake. The handshake includes authentication of both the device and the PKI server using their respective digital certificates. During the handshake they may also agree upon a random session key, which is subsequently used to provide an additional layer of encryption of the identity data. The UA of the device is included in the device's certificate, and the PKI server validates that the UA is included in its whitelist. The PKI server also validates the time stamp provided by the device against possible replay attacks. Any request from the same device with the same UA must have a timestamp that is greater than the last one received.

The PKI server provides the encrypted identity data to the network-enabled device at 17 and the device decrypts and validates the data at 18. At 19 the device installs the decrypted identity data. Typically, the network-enabled device will re-encrypt the identity data using a unique key that is hardware-protected so that it may be stored in its non volatile memory.

In the process described above in connection with FIG. 3, the identity data is encrypted with a current device key. In other cases, however, the KGF may encrypt all the new identity data with a global key, which, for example, may be common to a particular device model. In this case the whitelist is not delivered to the KGF as shown above at 5 since the KGF only needs to know how many new units of identity data need to be generated. Rather, the whitelist is delivered to the online PKI server so that it can check the authorization for each request.

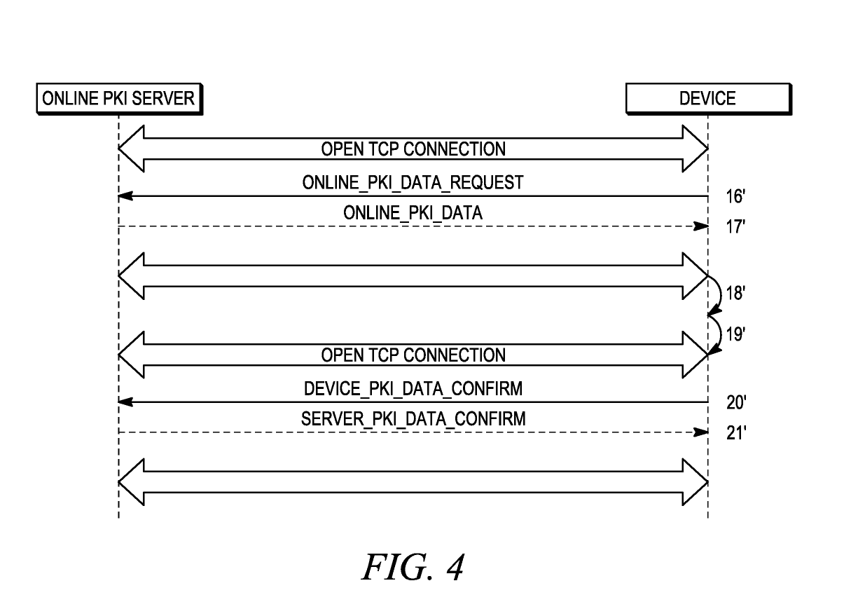

FIG. 4 shows in more detail the message exchange process between the online PKI server and the network-enabled device which corresponds to messages 16-19 in FIG. 1. As shown, a TCP connection is first established between the two devices over the Internet or other communications network. Then, at 16′ the network-enabled device sends an Online_PKI_Data_Request to the online PKI server requesting the identity data. The request includes a randomly generated key agreement public key of the device (for instance, a Diffie-Hellman public key or an Elliptic Curve Diffie-Hellman public key). The request is also digitally signed with the device's private key and includes an attached device certificate. Before providing a response, the online PKI server verifies the device signature, device certificate and UA included in the device certificate (against the whitelist). After successful validation, the PKI server then generates its own key agreement keypair and includes its key agreement public key in the response. The combination of the server's key agreement private key and the device's key agreement public key are used to generate a shared session key. The session key is then used to encrypt private or secret key data in the response (on top of encryption that was already applied at the KGF). In response, the PKI online server sends an Online_PKI_Data message to the network-enabled device at 17′ which includes the encrypted identity data. The same response message also includes the server's key agreement public key, the server's digital signature and certificate. At this point the TCP connection is terminated to allow the network-enabled device to perform its upgrade tasks offline. The network-enabled device first verifies the signature and server certificate in the response message. After successful verification, the device computes the same session key with its key agreement private key and the key agreement public key of the server. It then decrypts and validates the data at 18′ and installs the decrypted identity data at 19′. The device may also perform other related tasks at this point in time. For instance the device may establish communication with third-party servers to download other software which may require use of the new identity data. An example of such software is digital rights management (DRM) software.

Continuing with FIG. 4, after the network-enabled device has performed its upgrade tasks, the TCP connection to the online PKI server may be re-established. The network-enabled device then sends at 20′ a Device_PKI-Data-Confirm message to the online PKI server confirming receipt and installation of the identity data. Finally, at 21′ the online PKI server acknowledges the confirmation by sending a Server_PKI_Data_Confirm message to the network-enabled device. Steps 19-21 are optional and therefore in some implementations may be eliminated.

In an alternative embodiment, the Device_PKI-Data-Confirm message is sent to a separate Confirmation Server which operates independent of the on-line PKI Server. The Confirmation Server then acknowledges the receipt of the confirmation by sending a Server_PKI_Data_Confirm message to the network-enabled device.

As used in this application, the terms “component,” “module,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, wherein the invention is intended to be defined by the following claims—and their equivalents—in which all terms are mean in their broadest reasonable sense unless otherwise indicated.

1. A method for updating network-enabled devices with new identity data, comprising:
requesting new identity data for a plurality of network-enabled devices;
receiving notification that the new identity data is ready to be delivered to the plurality of network-enabled devices;
delivering a software object to the plurality of network-enabled devices over a first communications network, each of said software objects being configured to cause the network-enabled devices to download the new identity data to the respective network-enabled device over a second communications network and install the new identity data at a time based at least in part on information included with the software object.

2. The method of claim 1 further comprising providing a whitelist of the plurality of network-enabled devices that are to be updated.

3. The method of claim 1 wherein the second communications network is the Internet.

4. The method of claim 3 wherein the first communications network is operated by a service provider who also requests the new identity data for the plurality of network-enabled devices.

5. The method of claim 1 wherein the software objects are configured to cause the new identity data to be downloaded to the network-enabled devices at different times that are distributed over a prescribed time period.

6. The method of claim 5 wherein the different times are randomly selected.

7. The method of claim 1 wherein the identity data includes public key infrastructure (PKI) data.

8. The method of claim 7 wherein the PKI data includes a digital certificate and a private key.

9. A method for providing new identity data that is to replace prior identity data currently being used by a plurality of network-enabled devices, comprising:
receiving a request for new identity data for a plurality of network-enabled devices;
generating the new identity data for each network-enabled device specified with its own identifier on a whitelist;
encrypting the new identity data for each network-enabled device with a unique key that is accessible only to each respective network-enabled device and not other network-enabled devices;
loading the new identity data onto an on-line server accessible to the network-enabled devices over a communications network; and
causing the network-enabled devices to be notified that the new identity data is ready to be downloaded.

10. The method of claim 9 wherein causing the network-enabled devices to be notified that the new identity data is ready to be downloaded includes notifying a service provider who has also requested the new identity data on behalf of the plurality of network-enabled devices.

11. The method of claim 9 wherein the unique key is a private key respectively associated with each of the network-enabled devices.

12. The method of claim 11 wherein the unique key is included in the prior identity data.

13. The method of claim 9 wherein the request is received from a service provider and further comprising generating a whitelist of network-enabled devices associated with the service provider, said whitelist specifying the network-enabled devices for which the new identity data is to be generated.

14. The method of claim 9 wherein the request is received from a service provider and further comprising receiving from the service provider a whitelist specifying a subset of network-enabled devices associated with the service provider, each of which are to be provisioned with the new identity data.

15. One or more computer-readable media storing instructions executable by a computing system, comprising:
installing in a network-enabled device a software object received over a first communications network;
responsive to instructions from the software object, sending a request over a second communications network to receive new identity data for the network-enabled device to replace current identity data currently being used by the network-enabled device;
receiving the new identity data in an encrypted form over the second communications network;
decrypting the new identity data using a cryptographic key included in the current identity data; and
installing the decrypted identity data to replace the current identity data.

16. The one or more computer-readable media of claim 15 further comprising sending the request further includes sending the request at a time derived at least in part from information included with the software object.

17. The one or more computer-readable media of claim 15 wherein the first communications network is operated by a service provider who also requests creation of the new identity data.

18. The one or more computer-readable media of claim 15 wherein the request to receive the new identity data is sent at a time based at least in part on information included with the software object.

19. The one or more computer-readable media of claim 18 wherein the time is randomly selected within a prescribed time period.

20. The one or more computer-readable media of claim 15 wherein the cryptographic key is a private or secret key associated with the network-enabled devices.
